(19) United States
(12) Patent Application Publication
(10) Pub. No.: US 2021/0080911 A1
(43) Pub. Date: Mar. 18, 2021

(54) ELECTRONIC CALENDARING SYSTEM

(71) Applicant: Kristine M. Hoyt, Sanford, ME (US)

(72) Inventor: Kristine M. Hoyt, Sanford, ME (US)

(21) Appl. No.: 17/017,953

(22) Filed: Sep. 11, 2020

Related U.S. Application Data
(60) Provisional application No. 62/900,158, filed on Sep. 13, 2019.

(51) Int. Cl. G04G 9/00; G06F 1/16

(52) U.S. Cl. CPC G04G 9/0064; G06F 3/167; G06F 1/1605

(57) ABSTRACT

An electronic calendaring system having a program running thereon and connected to at least one mobile device, the electronic calendaring system including a main frame, and a display unit disposed on at least a portion of a front surface of the main frame to display a calendar thereon based on the program, such that the display unit allows input of at least one of a time and an event occurring on a selected day.

### CROSS REFERENCE TO RELATED APPLICATION

This application claims the benefit of, and incorporates by reference, U.S. provisional patent application Ser. No. 62/900,158, entitled “Electronic Calendaring System,” which was filed on Sep. 13, 2019.

### BACKGROUND

### 1. Field

The present general inventive concept relates generally to a calendar, and particularly, to an electronic calendaring system.

### 2. Description of the Related Art

Task organization is a challenge to many individuals. In particular, a modern family has multiple tasks to track, such as work schedules, children's activities, classes, doctor's appointments, sports games, and social events.

Typically, the family will keep notes on a refrigerator or write on a paper calendar. However, the paper notes and the paper calendar are susceptible to oversight and a member of the family's presence to actually create the notes or reminders. As such, creating the notes or reminders can be just as problematic as keeping tracking of each task.

Therefore, there is a need for an electronic calendaring system that can be updated quickly and remotely.

### SUMMARY

The present general inventive concept provides an electronic calendaring system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic calendaring system having a program running thereon and connected to at least one mobile device, the electronic calendaring system including a main frame, and a display unit disposed on at least a portion of a front surface of the main frame to display a calendar thereon based on the program, such that the display unit allows input of at least one of a time and an event occurring on a selected day.

The electronic calendaring system may further include a memory card port disposed on at least a portion of the main frame to receive a memory card therein, such that the display unit displays at least one of a screensaver, an image, and a picture thereon in response to inserting the memory card into the memory card port.

The electronic calendaring system may further include a control unit disposed within at least a portion of the main frame to send an alert to the display unit in response to determining a scheduling conflict exists between newly input information and existing information.

The control unit may determine the scheduling conflict due to the newly input information overlaps an event of the existing information.

The control unit may override the scheduling conflict in response to receiving confirmation on the display unit to store the newly input information.

The control unit via the program may generate a random code for at least one user, such that the control unit identifies the at least one user based on at least one of the random code and the newly input information.

The control unit may perform operations in response to receiving commands from the at least one mobile device.

The electronic calendaring system may further include a speaker disposed on at least a portion of the main frame to emit an alarm sound in response to determination of the scheduling conflict by the control unit, and send voice activated commands to the control unit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of an electronic calendaring system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Electronic Calendaring System 100

Main Frame 110

Front Surface 111

Rear Surface 112

Display Unit 120

Memory Card Port 130

Communication Unit 140

Control Unit 150

Input Unit 151

Processing Unit 152

Storage Unit 153

Speaker 160

Power Source 170

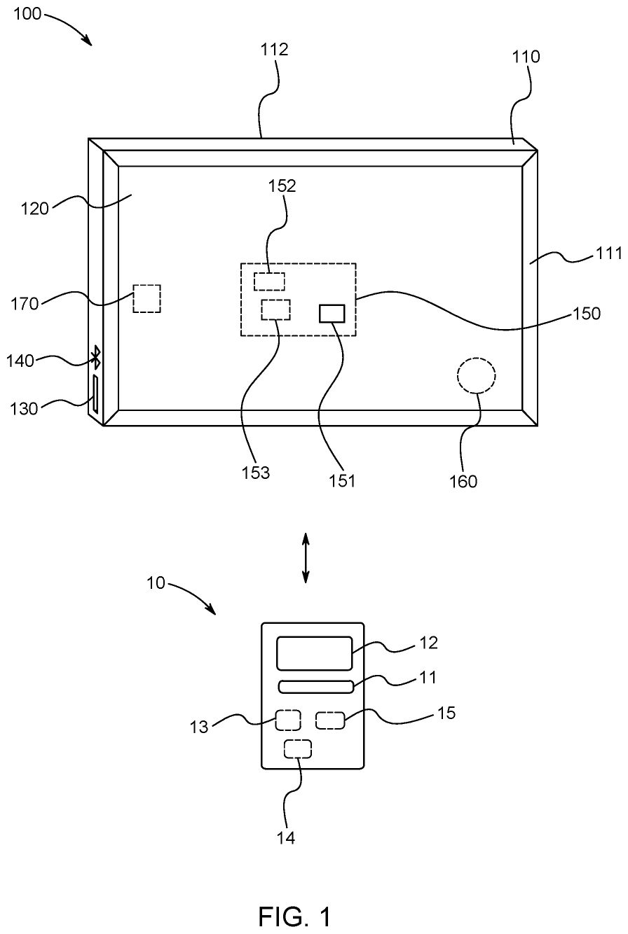

FIG. 1 illustrates a front perspective view of an electronic calendaring system 100, according to an exemplary embodiment of the present general inventive concept.

The electronic calendaring system 100 may be constructed from at least one of metal, plastic, wood, glass, and rubber, etc., but is not limited thereto.

The electronic calendaring system 100 may include a main frame 110, a display unit 120, a memory card port 130, a communication unit 140, a control unit 150, a speaker 160, and a power source 170, but is not limited thereto.

Referring to FIG. 1, the main frame 110 is illustrated to have a rectangular prism shape. However, the main frame 110 may be rectangular, circular, pentagonal, hexagonal, octagonal, or any other shape known to one of ordinary skill in the art, but is not limited thereto.

The main frame 110 may include a front surface 111 and a rear surface 112, but is not limited thereto.

The rear surface 112 may include a fastener disposed on at least a portion thereof, such as a hook and loop, a clasp, a clamp, a wire, a hook, and/or an adhesive (e.g., glue or tape).

The front surface 111 may have a size equivalent to the rear surface 112. The rear surface 112 may be removably disposed on a wall and/or any other planar surface. Alternatively, the main frame 110 may be disposed on any surface, using any portion of the main frame 110 as desired by a user.

The display unit 120 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 120 may be disposed on at least a portion the front surface 111.

The memory card port 130 may be disposed on at least a portion of a side of the main frame 110. However, the memory card port 130 may be disposed at any feasible location of the main frame 110. The memory card port 130 may receive a memory card, a memory chip, and/or a USB drive therein.

The communication unit 140 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The communication unit 140 may be disposed on and/or within at least a portion of the main frame 110.

The control unit 150 may include an input unit 151, a processing unit 152, and a storage unit 153, but is not limited thereto.

The input unit 151 may include a keyboard, a touchpad, a mouse, a trackball, a stylus, a voice recognition unit, a visual data reader, a camera, a wireless device reader, and a holographic input unit.

Also, the display unit 120 may be combined with the input unit 151 to be a touch-screen.

The processing unit 152 (or central processing unit, CPU) may include electronic circuitry to carry out instructions of a computer program by performing basic arithmetic, logical, control and input/output (I/O) operations specified by the instructions. The processing unit 152 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 152 may also include a microprocessor and a microcontroller.

The storage unit 153 may include a random access memory (RAM), a read-only memory (ROM), a hard disk, a flash drive, a database connected to the Internet, cloud-based storage, Internet-based storage, or any other type of storage unit.

The storage unit 153 may be preprogrammed with a calendar software application. For ease of description, the calendar software application will be hereinafter referred to as an app. The user may touch the display unit 120 to activate the electronic calendaring system 100. More specifically, the display unit 120 may illuminate in response to a touch by the user thereupon, such that the user may input further commands.

The display unit 120 via the app may display a calendar, such as a current year, a current month, and/or a current day. For example, the display unit 120 may display the current month including all days of the month. Moreover, the user may select a day of the current month on the display unit 120, such that a new screen may be displayed to allow the user to input information, such as a time and/or an event occurring on the selected day of the current month.

The processing unit 152 may retrieve any existing information on the selected day of the current month from the storage unit 153 to compare the inputted information with the existing information. The processing unit 152 may send an alert command to the display unit 120 to display a scheduling conflict in response to the comparison indicating the inputted information overlaps an event of the existing information. However, the user may override the alert and confirm on the display unit 120 to store the inputted information on the storage unit 153.

Alternatively, the processing unit 152 may store the entered information on the storage unit 153 in response to the processing unit 152 determining that no conflict exists. The entered information may include a name of the event, a description, a time, and a person associated with the event.

Additionally, the processing unit 152 via the app may load any year, month, and/or day that the user wishes to input, such as a plan, a reminder, and/or another event via the touch-screen of the display unit 120. In other words, the user may input any information for any timeframe in the electronic calendaring system 100.

The processing unit 152 may generate a random code for each person that uses the electronic calendaring system 100. More specifically, each person may have a unique random code to connect to the electronic calendaring system 100. As such, the electronic calendaring system 100 may identify a current user based on the random code and/or associate the inputted information with the current user and/or any other user based on the inputted information.

Furthermore, the control unit 150 may interface with at least one mobile device 10.

The at least one mobile device 10 may include an input unit 11, a display unit 12, a processing unit 13, a communication unit 14, and a storage unit 15, but is not limited thereto.

The input unit 11 may include a keyboard, a touchpad, a mouse, a trackball, a stylus, a voice recognition unit, a visual data reader, a camera, a wireless device reader, and a holographic input unit.

The display unit 12 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 12 may be combined with the input unit 11 to be a touch-screen.

The processing unit 13 (or central processing unit, CPU) may include electronic circuitry to carry out instructions of a computer program by performing basic arithmetic, logical, control and input/output (I/O) operations specified by the instructions. The processing unit 13 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 13 may also include a microprocessor and a microcontroller.

The communication unit 14 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 15 may include a random access memory (RAM), a read-only memory (ROM), a hard disk, a flash drive, a database connected to the Internet, cloud-based storage, Internet-based storage, or any other type of storage unit.

For ease of description, the at least one mobile device 10 will be hereinafter interpreted to be a smart phone with a touch-screen.

The at least one mobile device 10 may access the Internet via the communication unit 14 to allow the user to access a website, and/or may allow the app (i.e. the calendaring software application) to be executed using the processing unit 13. The app may be downloaded from the Internet to be stored on the storage unit 15. Moreover, the app may be designed to remotely control the control unit 150.

After executing the app, the user may perform any of the functions as described above with respect to the control unit 150. Additionally, the user may depress a button rendered on the display unit 12 to input another plan, another reminder and/or another event using the communication unit 14. As such, the processing unit 13 may transmit the another plan, the another reminder, and/or the another event to the communication unit 14, such that the communication unit 14 communicates with the communication unit 140. The processing unit 152 may retrieve the another plan, the another reminder, and/or the another event from the communication unit 140, and store the another plan, the another reminder, and/or the another event on the storage unit 153, unless a conflict exists, as previously described.

Furthermore, the at least one mobile device 10 may synchronize data with data on the storage unit 153, such that the electronic calendaring system 100 and the at least one mobile device 10 may have updated information. As such, any user may be made aware of important events and schedules on the display unit 12 of the at least one mobile device 10, such that a friend and/or a family member may be prevented from forgetting the important events and schedules. In other words, the processing unit 13 via the app may trigger a reminder alert on the display unit 12 due to monitoring of the important events and schedules stored on the storage unit 15.

The electronic calendaring system 100 may operate whether or not the communication unit 140 has a link established. For example, if an Internet connection is disconnected and/or malfunctioning, the processing unit 152 may process further inputs to the input unit 151. However, synchronization to the at least one mobile device 10 may not occur until the Internet connection is reestablished.

The memory card port 130 may receive the memory card to load a screensaver, an image, a picture, and/or additional information on the display unit 120. Moreover, the screensaver, the image, the picture, and/or the additional information may be stored on the storage unit 153 by the processing unit 152. As such, the screensaver, the image, the picture, and/or the additional information may be displayed on the display unit 120.

The speaker 160 may be disposed on and/or within at least a portion of the main frame 110. The speaker 160 may be used to emit sounds and/or music therefrom. For example, the processing unit 152 and/or the at least one mobile device 10 may be used to download and/or store the sounds and/or the music on the storage unit 153 via the communication unit 140, and/or via the communication unit 14 transmitting data to the communication unit 140, respectively.

Also, the speaker 160 may emit an alarm sound in response to a determination of the scheduling conflict, as described previously.

Alternatively, the speaker 160 may include a microphone, and be combined with the input unit 151, such that the electronic calendaring system 100 may be controlled using voice activation.

The power source 170 may be at least one of, a power inlet, a battery, and a solar cell, but is not limited thereto. Additionally, the battery may include lithium-ion, nickel cadmium, nickel metal hydride, alkaline, etc., but is not limited thereto. As such, the power source 170 may charge in response to exposure to a light source and/or receiving external power from a power outlet.

The power source 170 may send power to at least one of the display unit 120, the memory card port 130, the communication unit 140, the control unit 150, and the speaker 160.

Therefore, the electronic calendaring system 100 may facilitate tracking of multiple events for the user, as well as, any family members. Moreover, the electronic calendaring system 100 may synchronize remotely using the at least one mobile device 10, such that the user may not have to remember events to be recorded at a later time.

The present general inventive concept may include an electronic calendaring system 100 having a program running thereon and connected to at least one mobile device 10, the electronic calendaring system 100 including a main frame 110, and a display unit 120 disposed on at least a portion of a front surface 111 of the main frame 110 to display a calendar thereon based on the program, such that the display unit 120 allows input of at least one of a time and an event occurring on a selected day.

The electronic calendaring system 100 may further include a memory card port 130 disposed on at least a portion of the main frame 110 to receive a memory card therein, such that the display unit 120 displays at least one of a screensaver, an image, and a picture thereon in response to inserting the memory card into the memory card port 130.

The electronic calendaring system 100 may further include a control unit 150 disposed within at least a portion of the main frame 110 to send an alert to the display unit 120 in response to determining a scheduling conflict exists between newly input information and existing information.

The control unit 150 may determine the scheduling conflict due to the newly input information overlaps an event of the existing information.

The control unit 150 may override the scheduling conflict in response to receiving confirmation on the display unit 120 to store the newly input information.

The control unit 150 via the program may generate a random code for at least one user, such that the control unit 150 identifies the at least one user based on at least one of the random code and the newly input information.

The control unit 150 may perform operations in response to receiving commands from the at least one mobile device 10.

The electronic calendaring system 100 may further include a speaker 160 disposed on at least a portion of the main frame 110 to emit an alarm sound in response to determination of the scheduling conflict by the control unit 150, and send voice activated commands to the control unit 150.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An electronic calendaring system having a program running thereon and connected to at least one mobile device, the electronic calendaring system comprising:
a main frame; and
a display unit disposed on at least a portion of a front surface of the main frame to display a calendar thereon based on the program, such that the display unit allows input of at least one of a time and an event occurring on a selected day.

2. The electronic calendaring system of claim 1, further comprising:
a memory card port disposed on at least a portion of the main frame to receive a memory card therein, such that the display unit displays at least one of a screensaver, an image, and a picture thereon in response to inserting the memory card into the memory card port.

3. The electronic calendaring system of claim 1, further comprising:
a control unit disposed within at least a portion of the main frame to send an alert to the display unit in response to determining a scheduling conflict exists between newly input information and existing information.

4. The electronic calendaring system of claim 3, wherein the control unit determines the scheduling conflict due to the newly input information overlaps an event of the existing information.

5. The electronic calendaring system of claim 3, wherein the control unit overrides the scheduling conflict in response to receiving confirmation on the display unit to store the newly input information.

6. The electronic calendaring system of claim 3, wherein the control unit via the program generates a random code for at least one user, such that the control unit identifies the at least one user based on at least one of the random code and the newly input information.

7. The electronic calendaring system of claim 3, wherein the control unit performs operations in response to receiving commands from the at least one mobile device.

8. The electronic calendaring system of claim 3, further comprising:
a speaker disposed on at least a portion of the main frame to emit an alarm sound in response to determination of the scheduling conflict by the control unit, and send voice activated commands to the control unit.
